(19) United States
(12) Patent Application Publication
(10) Pub. No.: US 2025/0180715 A1
(43) Pub. Date: Jun. 5, 2025

(54) LIGHT RECEIVING DEVICE, DISTANCE MEASURING DEVICE, AND METHOD FOR CONTROLLING LIGHT RECEIVING DEVICE

(71) Applicant: Sony Semiconductor Solutions Corporation, Kanagawa (JP)

(72) Inventor: Takuya Yokoyama, Kanagawa (JP)

(21) Appl. No.: 18/563,059

(22) PCT Filed: Mar. 11, 2022
(86) PCT No.: PCT/JP2022/010852

§ 371 Date: Nov. 21, 2023

(30) Foreign Application Priority Data
Jul. 6, 2021 (JP) 2021-112229

(51) Int. Cl. G01S 7/486; G01S 7/481; G01S 7/484; G01S 7/4863; G01S 7/4865; G01S 7/497; G01S 17/14; G01S 17/931

(52) U.S. Cl. CPC G01S 7/4868; G01S 7/4817; G01S 7/484; G01S 7/4863; G01S 7/4866; G01S 7/497; G01S 17/14; G01S 17/931

(57) ABSTRACT

The light receiving device includes a light receiving unit and a controller. The light receiving unit includes a first light receiving element that receives light emitted by the first light emitting element and a second light receiving element that receives light emitted by a second light emitting element that is disposed adjacent to the first light emitting element and shares an anode terminal or a cathode terminal with the first light emitting element. The controller controls the first light receiving element and the second light receiving element so that the first light receiving element and the second light receiving element receive light when the first light receiving element emits light.

### FIELD

The present disclosure relates to a light receiving device, a distance measuring device, and a method for controlling the light receiving device.

### BACKGROUND

Conventionally, there is a distance measuring device that measures a distance to an object that is a reflector by emitting a laser beam to the outside and receiving reflected light, such as light detection and ranging (LiDAR). In this type of distance measuring device, abnormality of a light emitting element may be detected by a change in a voltage value applied to the light emitting element that emits a laser beam (see, for example, Patent Literature 1).

### CITATION LIST

### Patent Literature

Patent Literature 1: JP 2017-208195 A

### SUMMARY

### Technical Problem

However, in the conventional technique, there is an issue that abnormality of a light emitting element cannot be detected when a plurality of light emitting elements share an anode terminal or a cathode terminal. Therefore, the present disclosure proposes a light receiving device, a distance measuring device, and a method for controlling the light receiving device capable of detecting abnormality of a light emitting element in a case where a plurality of light emitting elements shares an anode terminal or a cathode terminal.

### Solution to Problem

In order to solve the above problem, a light receiving device according to one embodiment of the present disclosure includes: a light receiving unit including a first light receiving element that receives light emitted by a first light emitting element and a second light receiving element that receives light emitted by a second light emitting element that is disposed adjacent to the first light emitting element and shares an anode terminal or a cathode terminal with the first light emitting element; and a controller that controls the first light receiving element and the second light receiving element to cause the first light receiving element and the second light receiving element to receive light when the first light receiving element emits light.

### BRIEF DESCRIPTION OF DRAWINGS

FIG. 1 is a block diagram illustrating a schematic configuration example of a ToF sensor as a distance measuring device according to the present embodiment.

FIG. 2 is a diagram for explaining an optical system of the ToF sensor according to the present embodiment.

FIG. 3 is a block diagram illustrating a schematic configuration example of a light receiving unit according to the present embodiment.

FIG. 4 is a schematic diagram illustrating a schematic configuration example of an LD array and a SPAD array according to the present embodiment.

FIG. 5 is a circuit diagram illustrating a schematic configuration example of a SPAD pixel according to the present embodiment.

FIG. 6 is a block diagram illustrating a more detailed configuration example of a SPAD addition unit according to the present embodiment.

FIG. 7 is a diagram illustrating a histogram generated by a calculation unit.

FIG. 8 is a diagram illustrating a light emission pattern of a light emitting unit and a light reception pattern of a light receiving unit.

FIG. 9 is a diagram illustrating processing of pattern 2-1 in FIG. 8.

FIG. 10 is a diagram illustrating an example of a method for selecting a pattern.

FIG. 11 is a diagram illustrating processing of pattern 2-2 in FIG. 8.

FIG. 12 is a diagram illustrating an example of a method for selecting a pattern.

FIG. 13 is a diagram illustrating a light emission pattern of a light emitting unit and a light reception pattern of a light receiving unit.

FIG. 14 is a diagram illustrating processing of pattern 2-1 in FIG. 13.

FIG. 15 is a schematic diagram illustrating a schematic configuration example of the LD array.

FIG. 16 is a schematic diagram illustrating an example of a light reception pattern in the SPAD array.

FIG. 17 is a schematic diagram illustrating an example of a light reception pattern in the SPAD array.

FIG. 18 is a flowchart illustrating a processing procedure of entire processing executed by the ToF sensor.

FIG. 19 is a flowchart illustrating a processing procedure in a case where a failure occurs.

FIG. 20 is a block diagram illustrating an example of a schematic configuration of a vehicle control system.

FIG. 21 is an explanatory diagram illustrating an example of installation positions of an outside-vehicle information detector and an imaging unit.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Furthermore, in the specification and the drawings, a plurality of constituent elements having substantially the same functional configuration may be distinguished from one another by adding different numbers after the same reference numeral. However, if it is not necessary to distinguish the plurality of constituent elements having substantially the same functional configuration from one another, only the same reference numeral is given.

Note that the description will be given in the following order.
1. Embodiment
1.1 Distance Measuring Device (ToF Sensor)
1.2 Optical System
1.3 Light Receiving Unit
1.4 LD Array and SPAD Array
1.5 SPAD Pixel
1.6 Schematic Operation Example of SPAD Pixel
1.7 SPAD Addition Unit
1.8 Sampling Cycle
1.9 Histogram
1.10 Abnormality Detection Method (1)
1.11 Abnormality Detection Method (2)
1.12 Abnormality Detection Method (3)
1.13 Abnormality Detection Method (4)
2. Application Example
3. Summary

### 1. EMBODIMENT

First, an embodiment will be described in detail below with reference to the drawings.

### 1.1 Distance Measuring Device (ToF Sensor)

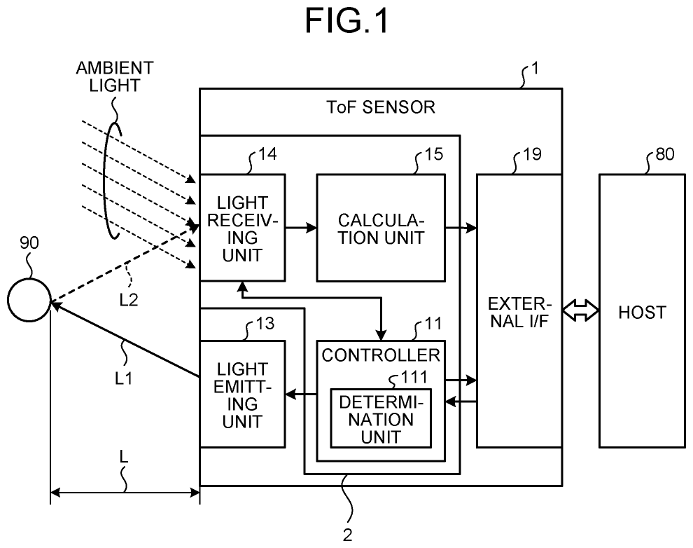

FIG. 1 is a block diagram illustrating a schematic configuration example of a ToF sensor as a distance measuring device according to the present embodiment. As illustrated in FIG. 1, the ToF sensor 1 includes a controller 11, a light emitting unit 13, a light receiving unit 14, a calculation unit 15, and an external interface (I/F) 19. The controller 11, the light receiving unit 14, and the calculation unit 15 are included in the light receiving device 2.

The controller 11 includes, for example, an information processing apparatus such as a central processing unit (CPU) and controls each unit of the ToF sensor 1. Furthermore, the controller 11 controls to read the detection signal from the light receiving unit 14 and perform distance measurement. Furthermore, the controller 11 includes a determination unit 111 that determines abnormality of the light emitting unit 13.

The external I/F 19 may be, for example, a communication adapter for establishing communication with the external host 80 via a communication network conforming to an arbitrary standard such as a controller area network (CAN), a local interconnect network (LIN), or FlexRay (registered trademark) in addition to a wireless local area network (LAN) or a wired LAN.

Here, for example, in a case where the ToF sensor 1 is mounted on a mobile body such as an automobile, the host 80 may be an engine control unit (ECU) mounted on an automobile or the like. Furthermore, in a case where the ToF sensor 1 is mounted on an autonomous mobile robot such as a domestic pet robot or an autonomous mobile body such as a robot cleaner, an unmanned aerial vehicle, or a following conveyance robot, the host 80 may be a control device or the like that controls the autonomous mobile body.

Although details will be described later, the light emitting unit 13 includes, for example, semiconductor laser diodes as a plurality of light emitting elements arranged in a one-dimensional array along the vertical direction as a light source, and emits a pulsed laser beam L1 having a predetermined time width at a predetermined cycle (also referred to as a light emission cycle). In addition, the light emitting unit 13 emits the laser beam L1 having a time width of 1 ns (nanosecond) at a cycle of 1 MHz (megahertz), for example. For example, in a case where an object 90 is present within the distance measurement range, the laser beam L1 emitted from the light emitting unit 13 is reflected by the object 90 and enters the light receiving unit 14 as reflected light L2.

Although details will be described later, the light receiving unit 14 includes, for example, SPAD pixels that are a plurality of light receiving elements arranged in a two-dimensional lattice pattern and each receiving light from a plurality of semiconductor laser diodes, and outputs information regarding the number (for example, corresponding to the number of detection signals to be described later) of SPAD pixels (hereinafter, referred to as the number of detections) in which incidence of photons has been detected after light emission by the light emitting unit 13. For example, the light receiving unit 14 detects incidence of photons at a predetermined sampling cycle for one light emission of the light emitting unit 13 and outputs the number of detected photons.

The calculation unit 15 aggregates the number of detections output from the light receiving unit 14 for each of a plurality of SPAD pixels (for example, corresponding to one or a plurality of macro pixels to be described later), and creates a histogram in which the horizontal axis is the time-of-flight and the vertical axis is the accumulated pixel value on the basis of the pixel values obtained by the aggregation. For example, the calculation unit 15 repeatedly executes, for a plurality of times of light emission of the light emitting unit 13, obtaining a pixel value by aggregating the number of detections at a predetermined sampling frequency for one light emission of the light emitting unit 13, thereby creating a histogram in which the horizontal axis (bin of the histogram) is a sampling cycle corresponding to the time-of-flight and the vertical axis is an accumulated pixel value obtained by accumulating pixel values obtained in each sampling cycle.

In addition, after performing predetermined filter processing on the created histogram, the calculation unit 15 specifies the time-of-flight when the accumulated pixel value reaches the peak from the histogram after the filter processing. Then, the calculation unit 15 calculates the distance from the ToF sensor 1 or the device equipped with the ToF sensor 1 to the object 90 present within the distance measurement range on the basis of the specified time-of-flight. Note that the information on the distance calculated by the calculation unit 15 may be output to the host 80 or the like via the external I/F 19, for example.

### 1.2 Optical System

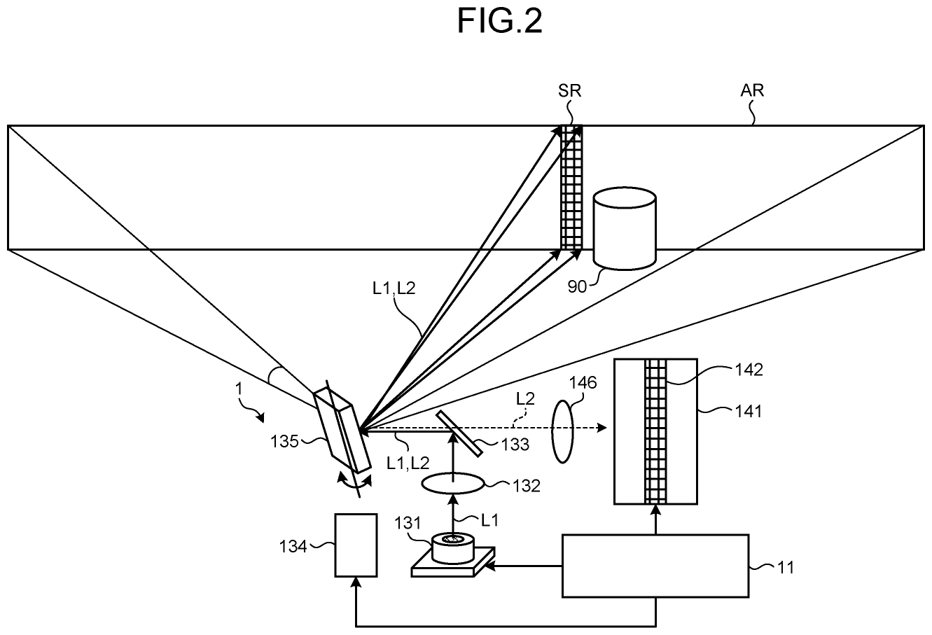

FIG. 2 is a diagram for explaining an optical system of the ToF sensor according to the present embodiment. FIG. 2 illustrates a so-called scanning type optical system that scans the angle of view of the light receiving unit 14 in the horizontal direction.

As illustrated in FIG. 2, the ToF sensor 1 includes, as an optical system, an LD array 131, a collimator lens 132, a half mirror 133, a galvano mirror 135, a light receiving lens 146, and a SPAD array 141. The LD array 131, the collimator lens 132, the half mirror 133, and the galvano mirror 135 are included in, for example, the light emitting unit 13 in FIG. 1. Furthermore, the light receiving lens 146 and the SPAD array 141 are included in the light receiving unit 14 in FIG. 1, for example.

In the configuration illustrated in FIG. 2, the collimator lens 132 converts the laser beam L1 emitted from the LD array 131 into rectangular parallel beam having an intensity spectrum of a cross section that is long in the vertical direction, and then the laser beam L1 enters the half mirror 133. The half mirror 133 reflects a part of the incident laser beam L1. The laser beam L1 reflected by the half mirror 133 is incident on the galvano mirror 135. For example, the galvano mirror 135 vibrates in the horizontal direction about a predetermined rotation axis by a drive unit 134 that operates based on the control from the controller 11. As a result, the laser beam L1 is horizontally scanned such that an angle of view SR of the laser beam L1 reflected by the galvano mirror 135 reciprocating scans in a distance measurement range AR in the horizontal direction. In other words, the drive unit 134 and the galvano mirror 135 function as a scanning unit that scans light emitted from the LD array 131 along the horizontal direction. Note that a micro electro mechanical system (MEMS), a micromotor, or the like can be used for the drive unit 134.

The laser beam L1 reflected by the galvano mirror 135 is reflected by the object 90 existing in the distance measurement range AR and enters the galvano mirror 135 as the reflected light L2. A part of the reflected light L2 incident on the galvano mirror 135 is transmitted through the half mirror 133 and incident on the light receiving lens 146, thereby forming an image on a specific SPAD array 142 in the SPAD array 141. Note that the SPAD array 142 may be the entire SPAD array 141 or a part thereof.

### 1.3 Light Receiving Unit

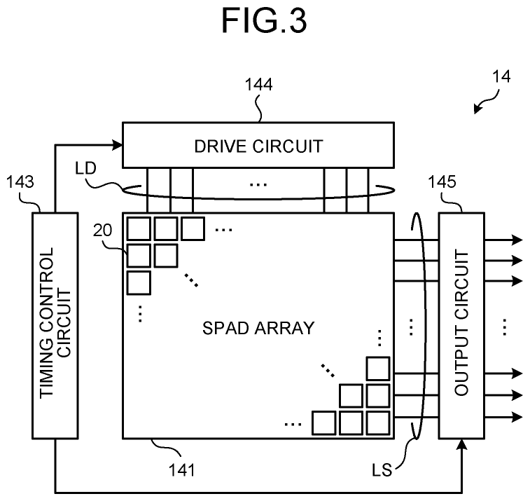

FIG. 3 is a block diagram illustrating a schematic configuration example of a light receiving unit according to the present embodiment. As illustrated in FIG. 3, the light receiving unit 14 includes a SPAD array 141, a timing control circuit 143, a drive circuit 144, and an output circuit 145.

The SPAD array 141 includes a plurality of SPAD pixels 20 arranged in a two-dimensional lattice pattern. To the plurality of SPAD pixels 20, a pixel drive line LD (vertical direction in the drawing) is connected for each column, and an output signal line LS (horizontal direction in the drawing) is connected for each row. One end of the pixel drive line LD is connected to an output end corresponding to each column of the drive circuit 144, and one end of the output signal line LS is connected to an input end corresponding to each row of the output circuit 145.

In the present embodiment, the reflected light L2 is detected using the entire or a part of the SPAD array 141. The region (SPAD array 142) used in the SPAD array 141 may be a rectangle that is long in the vertical direction and is the same as the image of the reflected light L2 formed on the SPAD array 141 when the entire laser beam L1 is reflected as the reflected light L2. However, the present invention is not limited thereto, and various modifications such as a region larger or a region smaller than the image of the reflected light L2 formed on the SPAD array 141 may be made.

The drive circuit 144 includes a shift register, an address decoder, and the like, and drives each SPAD pixel 20 of the SPAD array 141 at the same time for all pixels, in units of columns, or the like. Therefore, the drive circuit 144 includes at least a circuit that applies a quench voltage V_QCH to be described later to each SPAD pixel 20 in the select column in the SPAD array 141 and a circuit that applies a selection control voltage V_SEL to be described later to each SPAD pixel 20 in the select column. Then, the drive circuit 144 applies the selection control voltage V_SEL to the pixel drive line LD corresponding to the column to be read, thereby selecting the SPAD pixels 20 to be used for detecting incidence of photons in units of columns.

A signal (referred to as a detection signal) V_OUT output from each SPAD pixel 20 of the column selectively scanned by the drive circuit 144 is input to the output circuit 145 through each of the output signal lines LS. The output circuit 145 outputs the detection signal V_OUT input from each SPAD pixel 20 to the SPAD addition unit 40 provided for each macro pixel described later.

The timing control circuit 143 includes a timing generator or the like that generates various timing signals, and controls the drive circuit 144 and the output circuit 145 on the basis of the various timing signals generated by the timing generator.

### 1.4 LD Array and SPAD Array

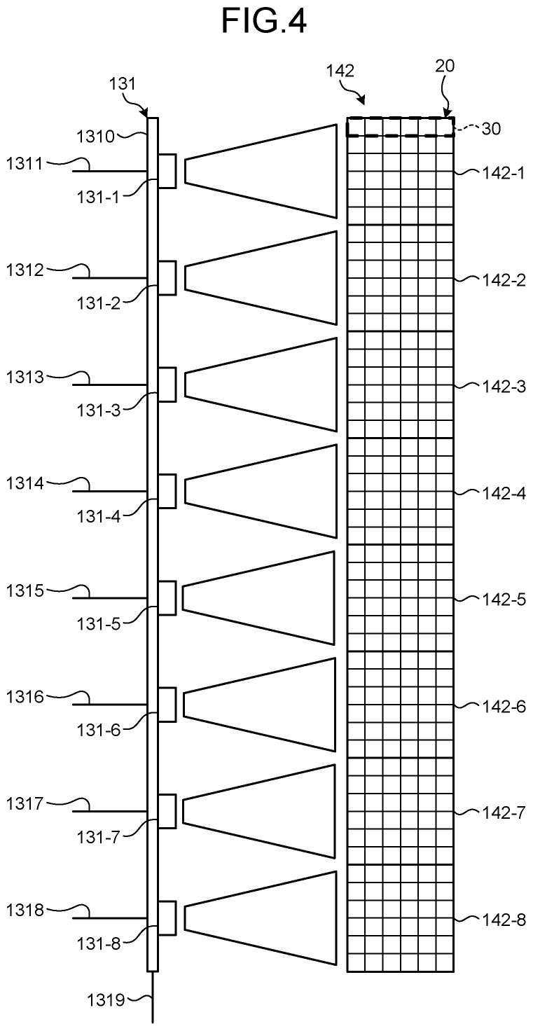

FIG. 4 is a schematic diagram illustrating a schematic configuration example of the LD array and the SPAD array according to the present embodiment. As illustrated in FIG. 4, the LD array 131 has a configuration in which, for example, LDs 131-1 to 131-8, which are a plurality of semiconductor laser diodes mounted on a substrate 1310, are arranged in a one-dimensional array along a vertical direction. In other words, the LD array 131 includes, for example, the LDs 131-1 to 131-8 arranged adjacent to each other in order along the vertical direction. Each of the LDs 131-1 to 131-8 has one anode terminal 1311 to 1318, respectively, and shares one cathode terminal 1319. In the present embodiment, an example in which the LDs 131-1 to 131-8 share one cathode terminal 1319 will be described, but the LDs 131-1 to 131-8 may share one anode terminal. Furthermore, in the present embodiment, an example in which the LD array 131 includes eight LDs will be described, but the number of LDs only needs to be plural.

The SPAD array 142 has, for example, a configuration in which a plurality of SPAD pixels 20 is arranged in a two-dimensional lattice pattern. The plurality of SPAD pixels 20 are grouped into a plurality of macro pixels 30 each including a predetermined number of SPAD pixels 20 arranged in the row and/or column direction. The shape of the region connecting the outer edges of the SPAD pixels 20 located at the outermost periphery of each macro pixel 30 is a predetermined shape (for example, a rectangle).

The SPAD array 142 includes, for example, a plurality of macro pixels 30 arranged in the vertical direction (corresponding to the column direction). In the present embodiment, the SPAD array 142 is divided into a plurality of regions (hereinafter, referred to as a SPAD region.) in the vertical direction, for example. In the example illustrated in FIG. 4, the SPAD array 142 is divided into eight SPAD regions 142-1 to 142-8 that receive the laser beams emitted from the LDs 131-1 to 131-8, respectively. The uppermost SPAD region 142-1 corresponds to, for example, the uppermost 1/8 region in the angle of view SR of the SPAD array 142, and receives the laser beam emitted from the LD 131-1. Similarly, the SPAD region 142-2 thereunder corresponds to, for example, the second 1/8 region from the top in the angle of view SR, and receives the laser beam emitted from the LD 131-2. Similarly, the SPAD regions 142-3 to 142-8 correspond to 1/8 regions in the angle of view SR, respectively, and receive the laser beams emitted from the LDs 131-3 to 131-8.

### 1.5 SPAD Pixel

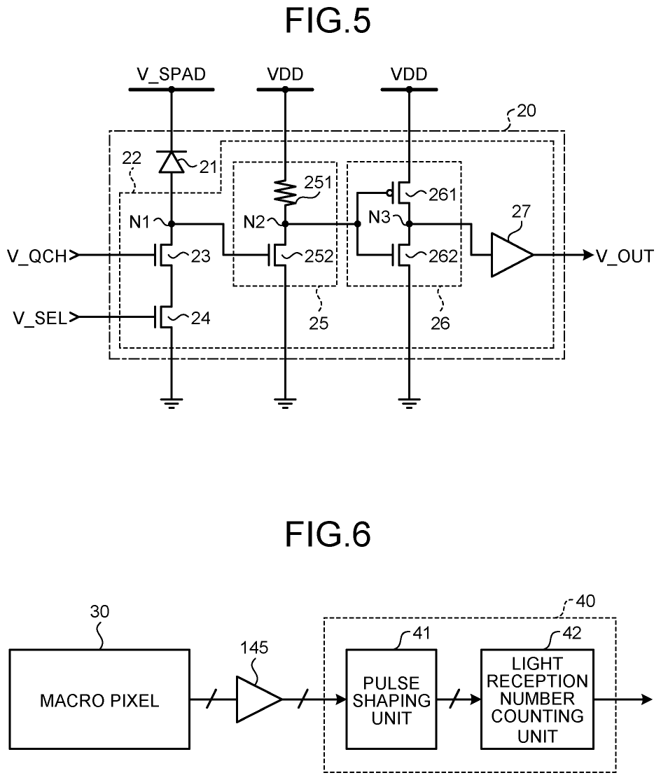

FIG. 5 is a circuit diagram illustrating a schematic configuration example of the SPAD pixel according to the present embodiment. As illustrated in FIG. 5, the SPAD pixel 20 includes a photodiode 21 as a light receiving element and a readout circuit 22 that detects incidence of a photon on the photodiode 21. When a photon enters the photodiode 21 in a state where a reverse bias voltage V_SPAD equal to or higher than a breakdown voltage is applied between an anode and a cathode of the photodiode, an avalanche current is generated.

The readout circuit 22 includes a quench resistor 23, a digital converter 25, an inverter 26, a buffer 27, and a selection transistor 24. The quench resistor 23 is, for example, an N-type metal oxide semiconductor field effect transistor (MOSFET: hereinafter referred to as an NMOS transistor), the drain of which is connected to the anode of the photodiode 21, and the source of which is grounded via the selection transistor 24. In addition, a quench voltage V_QCH set in advance for causing the NMOS transistor to act as a quench resistor is applied from the drive circuit 144 to the gate of the NMOS transistor constituting the quench resistor 23 via the pixel drive line LD.

In the present embodiment, the photodiode 21 is a SPAD. The SPAD is an avalanche photodiode that operates in Geiger mode when a reverse bias voltage equal to or higher than a breakdown voltage is applied between an anode and a cathode of the SPAD, and can detect incidence of one photon.

The digital converter 25 includes a resistor 251 and an NMOS transistor 252. A drain of the NMOS transistor 252 is connected to a power supply voltage VDD via the resistor 251, and a source thereof is grounded. In addition, a voltage at a connection point N1 between the anode of the photodiode 21 and the quench resistor 23 is applied to the gate of the NMOS transistor 252.

The inverter 26 includes a P-type MOSFET transistor (hereinafter, referred to as a PMOS transistor) 261 and an NMOS transistor 262. A drain of the PMOS transistor 261 is connected to the power supply voltage VDD, and a source thereof is connected to a drain of the NMOS transistor 262. The drain of the NMOS transistor 262 is connected to the source of the PMOS transistor 261, and a source thereof is grounded. A voltage at a connection point N2 between the resistor 251 and the drain of the NMOS transistor 252 is applied to the gate of the PMOS transistor 261 and the gate of the NMOS transistor 262, respectively. The output of the inverter 26 is input to the buffer 27.

The buffer 27 is a circuit for impedance conversion. When an output signal is input from the inverter 26, the buffer converts the impedance of the output signal that is input and outputs the converted signal as a detection signal V_OUT.

The selection transistor 24 is, for example, an NMOS transistor, a drain of which is connected to the source of the NMOS transistor constituting the quench resistor 23, and a source of which is grounded. The selection transistor 24 is connected to the drive circuit 144, and changes from the OFF state to the ON state when the selection control voltage V_SEL from the drive circuit 144 is applied to the gate of the selection transistor 24 via the pixel drive line LD.

### 1.6 Schematic Operation Example of SPAD Pixel

The readout circuit 22 illustrated in FIG. 5 operates as follows, for example. That is, first, during a period in which the selection control voltage V_SEL is applied from the drive circuit 144 to the selection transistor 24 and the selection transistor 24 is in the ON state, the reverse bias voltage V_SPAD equal to or higher than the breakdown voltage is applied to the photodiode 21. As a result, the operation of the photodiode 21 is permitted.

On the other hand, during a period in which the selection control voltage V_SEL is not applied from the drive circuit 144 to the selection transistor 24 and the selection transistor 24 is in the OFF state, the reverse bias voltage V_SPAD is not applied to the photodiode 21, so that the operation of the photodiode 21 is prohibited.

When a photon enters the photodiode 21 while the selection transistor 24 is in the ON state, an avalanche current is generated in the photodiode 21. As a result, an avalanche current flows through the quench resistor 23, and the voltage at the connection point N1 increases. When the voltage at the connection point N1 becomes higher than the ON state voltage of the NMOS transistor 252, the NMOS transistor 252 becomes in the on state, and the voltage at the connection point N2 changes from the power supply voltage VDD to 0 V. When the voltage at the connection point N2 changes from the power supply voltage VDD to 0 V, the PMOS transistor 261 changes from the OFF state to the ON state, the NMOS transistor 262 changes from the ON state to the OFF state, and the voltage at the connection point N3 changes from 0 V to the power supply voltage VDD. As a result, the high-level detection signal V_OUT is output from the buffer 27.

Thereafter, when the voltage at the connection point N1 continues to increase, the voltage applied between the anode and the cathode of the photodiode 21 becomes smaller than the breakdown voltage, whereby the avalanche current stops and the voltage at the connection point N1 decreases. Then, when the voltage at the connection point N1 becomes lower than the ON-state voltage of the NMOS transistor 252, the NMOS transistor 252 becomes in the OFF state, and the output of the detection signal V_OUT from the buffer 27 is stopped (low level).

As described above, the readout circuit 22 outputs the high-level detection signal V_OUT during a period from the timing at which the photon enters the photodiode 21 to generate the avalanche current, and the NMOS transistor 252 becomes in the ON state to the timing at which the avalanche current stops and the NMOS transistor 252 becomes in the OFF state. The output detection signal V_OUT is input to the SPAD addition unit 40 for each macro pixel 30 via the output circuit 145. Therefore, the detection signal V_OUT of the number (the number of detection) of SPAD pixels 20 in which the incidence of photons is detected among the plurality of SPAD pixels 20 constituting one macro pixel 30 is input to each SPAD addition unit 40.

### 1.7 SPAD Addition Unit

FIG. 6 is a block diagram illustrating a more detailed configuration example of the SPAD addition unit according to the present embodiment. Note that the SPAD addition unit 40 may be included in the light receiving unit 14 or may be included in the calculation unit 15.

As illustrated in FIG. 6, the SPAD addition unit 40 includes, for example, a pulse shaping unit 41 and a light reception number counting unit 42.

The pulse shaping unit 41 shapes the pulse waveform of the detection signal V_OUT input from the SPAD array 141 via the output circuit 145 into a pulse waveform having a time width according to the operation clock of the SPAD addition unit 40.

The light reception number counting unit 42 counts the detection signal V_OUT input from the corresponding macro pixel 30 for each sampling cycle, thereby counting the number (the number of detection) of the SPAD pixels 20 in which the incidence of photons is detected for each sampling cycle, and outputs the counted value as the pixel value of the macro pixel 30.

### 1.8 Sampling Cycle

Here, the sampling cycle is a cycle of measuring a time (time-of-flight) from when the light emitting unit 13 emits the laser beam L1 to when the light receiving unit 14 detects incidence of photons. As the sampling cycle, a cycle shorter than the light emission cycle of the light emitting unit 13 is set. For example, by shortening the sampling cycle, it is possible to calculate the time-of-flight of the photon emitted from the light emitting unit 13 and reflected by the object 90 with higher time resolution. This means that the distance to the object 90 can be calculated with a higher distance measurement resolution by increasing the sampling frequency.

For example, if a time-of-flight is set to t until when the light emitting unit 13 emits the laser beam L1, the laser beam L1 is reflected by the object 90, and the reflected light L2 is incident on the light receiving unit 14, distance L to the object 90 can be calculated as the following equation (1) since the light speed C is constant (C≈300,000,000 m (meters)/s (seconds)).

$$L = C \times t / 2 \qquad ( 1 )$$

Therefore, when the sampling frequency is 1 GHZ, the sampling cycle is 1 ns (nanosecond). In that case, one sampling cycle corresponds to 15 cm (centimeter). This indicates that the distance measurement resolution is 15 cm when the sampling frequency is 1 GHz. In addition, when the sampling frequency is doubled to 2 GHz, the sampling cycle is 0.5 ns (nanoseconds), and thus one sampling cycle corresponds to 7.5 cm (centimeters). This indicates that the distance measurement resolution can be set to 1/2 when the sampling frequency is doubled. In this way, by increasing the sampling frequency and shortening the sampling cycle, the distance to the object 90 can be calculated more accurately.

### 1.9 Histogram

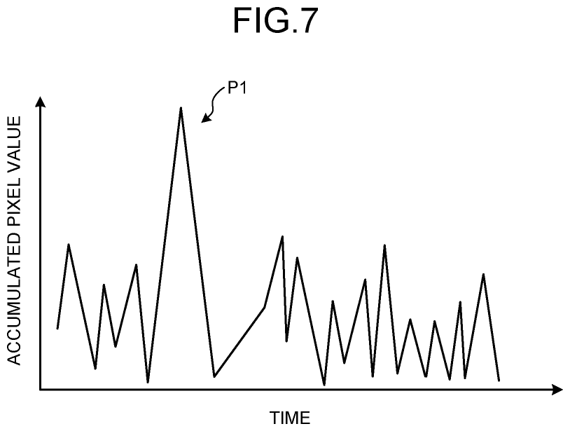

FIG. 7 illustrates a histogram generated by the above-described calculation unit 15. Specifically, FIG. 7 illustrates a gram obtained by linearizing a histogram in which the vertical axis represents an accumulated pixel value and the horizontal axis represents time (time-of-flight). As illustrated in FIG. 7, when there is the object 90 (see FIG. 1) in the region detected by the ToF sensor 1, a peak P1 corresponding to the object 90 that is a reflector appears in the histogram. The peak P1 has a peak width close to the pulse width of the laser beam L1.

### 1.10 Abnormality Detection Method (1)

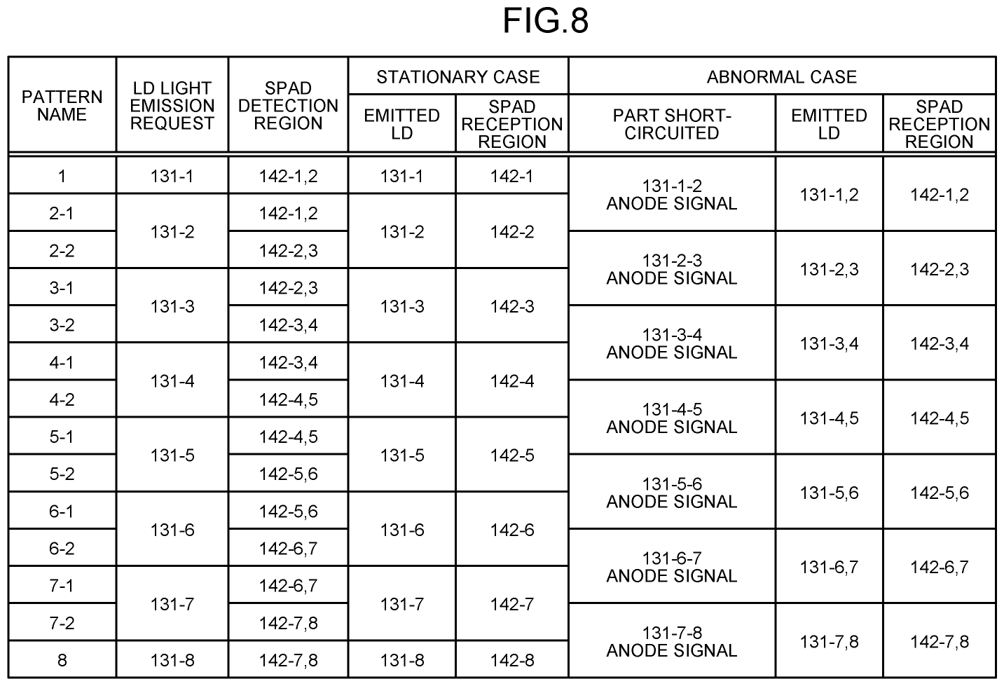

FIG. 8 is a diagram illustrating a light emission pattern of a light emitting unit and a light reception pattern of a light receiving unit. FIG. 8 illustrates, from the left, the pattern names, the LDs numbers 131-1 to 131-8 required to emit light, the SPAD regions numbers 142-1 to 142-8 required to be detected, the LDs numbers 131-1 to 131-8 emitting light in a stationary case, the SPAD regions numbers 142-1 to 142-8 detecting light in the stationary case, the parts short-circuited in an abnormal case, the LDs numbers 131-1 to 131-8 emitting light in the abnormal case, and the SPAD regions numbers 142-1 to 142-8 detecting light in the abnormal case.

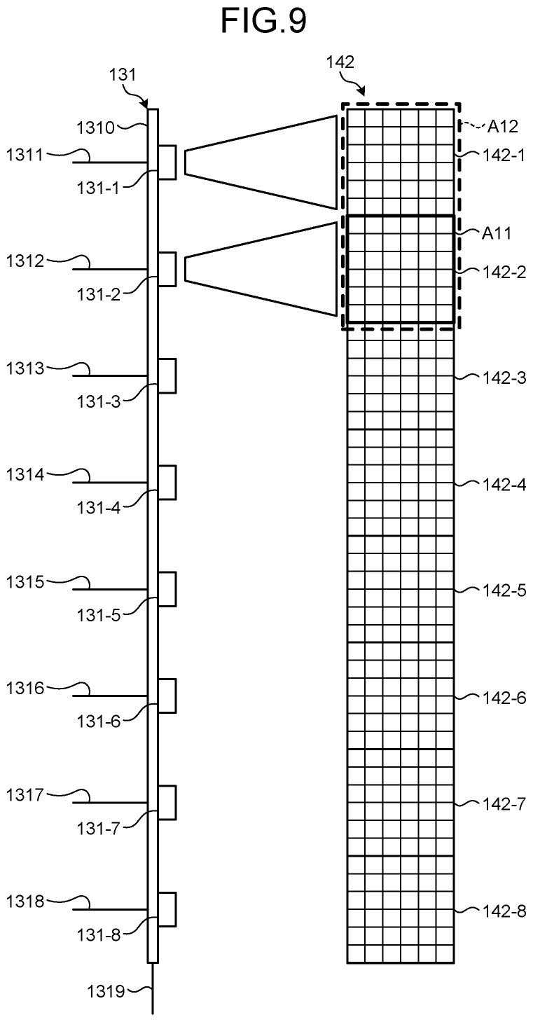

FIG. 9 is a diagram illustrating processing of pattern 2-1 in FIG. 8. In the processing of pattern 2-1, a region irradiated with light by the LDs 131-1 to 131-8 is A11, and a region where the SPAD regions 142-1 to 142-8 detect the light is A12. Specifically, the controller 11 causes the LD 131-2 to emit light on the basis of the LD light emission request, and causes the SPAD region 142-1 and the SPAD region 142-2 to detect light on the basis of the SPAD detection region. As described above, when any one of the LDs 131-1 to 131-8 emits light, the controller 11 controls the SPAD regions 142-1 to 142-8 so that the light is received by the SPAD region that receives light from the LD that has emitted light and the SPAD region that receives light from the LD adjacent to the LD that has emitted light.

At this time, in the stationary case where no failure occurs in the LDs 131-1 to 131-8, the LD 131-2 emits light, the SPAD region 142-2 detects the light, and the SPAD region 142-1 does not detect the light.

On the other hand, in the abnormal case where a short circuit occurs between the anode terminal 1311 of the LD 131-1 and the anode terminal 1312 of the LD 131-2, the power applied to the LD 131-2 is applied to the LD 131-1 and the LD 131-2 by half, and both the LD 131-1 and the LD 131-2 emit light. Then, both the SPAD region 142-1 and the SPAD region 142-2 detect light. Therefore, in the processing of pattern 2-1, when both the SPAD region 142-1 and the SPAD region 142-2 detect light, it is found that a short circuit occurs between the anode terminal 1311 and the anode terminal 1312. Therefore, in a case where both the SPAD region 142-1 and the SPAD region 142-2 detect light when the LD 131-2 emits light, the determination unit 111 determines that the light emitting unit 13 is abnormal.

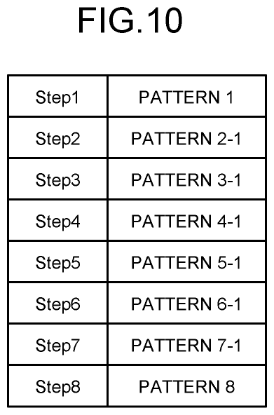

FIG. 10 is a diagram illustrating an example of a method for selecting a pattern. As illustrated in FIG. 10, when the processing of patterns 1, 2-1 to 7-1, and 8 is executed at Steps 1 to 8, it is possible to identify whether or not a short circuit has occurred in the anode terminals 1311 to 1318 of the LDs 131-1 to 131-8, and further, it is possible to identify a part where a short circuit has occurred.

In the stationary case and the abnormal case, the total amount of power applied to the LD array 131 does not change, and thus, it is not possible to detect a short circuit of the LD array 131 using a voltage value or the like. In addition, in a case where the anode terminal and the cathode terminal are not common, and the plurality of light emitting elements have the anode terminal and the cathode terminal, respectively, a short circuit can be detected using a voltage value or the like, but the LD array 131 cannot be downsized.

### 1.11 Abnormality Detection Method (2)

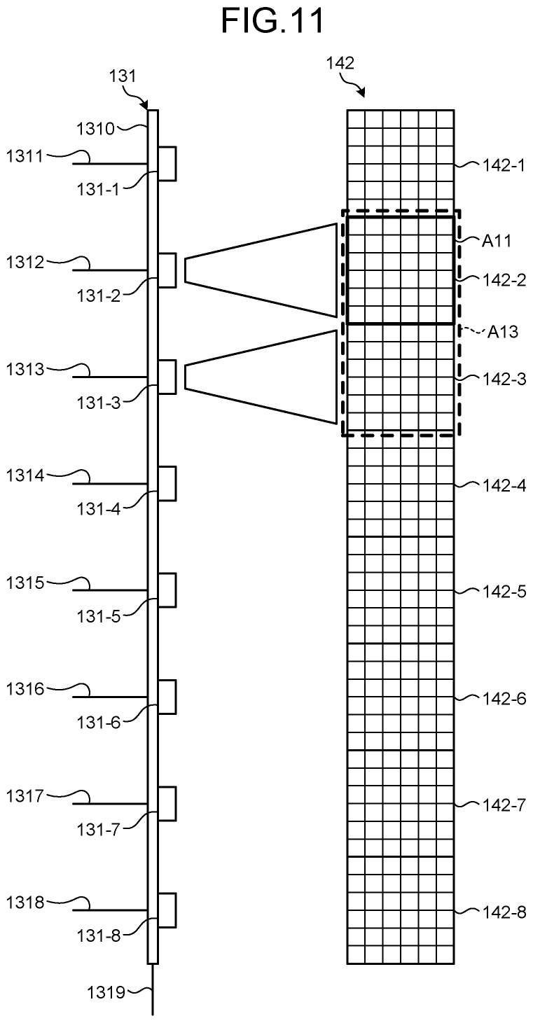

FIG. 11 is a diagram illustrating processing of pattern 2-2 in FIG. 8. In the processing of pattern 2-2, a region irradiated with light by the LDs 131-1 to 131-8 is A11, and a region where the SPAD regions 142-1 to 142-8 detect the light is A13. Specifically, the controller 11 causes the LD 131-2 to emit light on the basis of the LD light emission request, and causes the SPAD region 142-2 and the SPAD region 142-3 to detect light on the basis of the SPAD detection region.

At this time, in the stationary case where no failure occurs in the LDs 131-1 to 131-8, the LD 131-2 emits light, the SPAD region 142-2 detects the light, and the SPAD region 142-3 does not detect the light.

On the other hand, in the abnormal case where a short circuit occurs between the anode terminal 1312 of the LD 131-2 and the anode terminal 1313 of the LD 131-3, the power applied to the LD 131-2 is applied to the LD 131-2 and the LD 131-3 by half, and both the LD 131-2 and the LD 131-3 emit light. Then, both the SPAD region 142-2 and the SPAD region 142-3 detect light. Therefore, in the processing of pattern 2-2, when both the SPAD region 142-2 and the SPAD region 142-3 detect light, it is found that a short circuit occurs between the anode terminal 1312 and the anode terminal 1313.

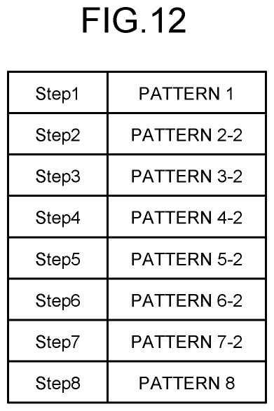

FIG. 12 is a diagram illustrating an example of a method for selecting a pattern. As illustrated in FIG. 12, when the processing of patterns 1, 2-2 to 7-2, and 8 is executed at Steps 1 to 8, it is possible to identify whether or not a short circuit has occurred in the anode terminals 1311 to 1318 of the LDs 131-1 to 131-8, and further, it is possible to identify a part where a short circuit has occurred.

### 1.12 Abnormality Detection Method (3)

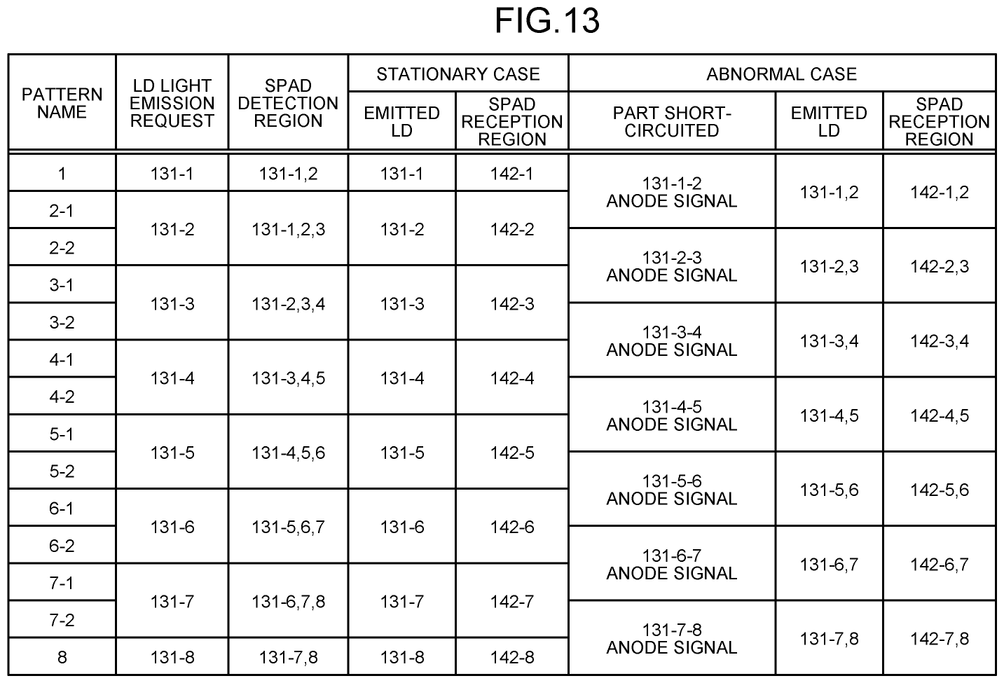

FIG. 13 is a diagram illustrating a light emission pattern of a light emitting unit and a light reception pattern of a light receiving unit. FIG. 13 illustrates, similarly to FIG. 8, from the left, the pattern names, the LDs numbers 131-1 to 131-8 required to emit light, the SPAD regions numbers 142-1 to 142-8 required to be detected, the LDs numbers 131-1 to 131-8 emitting light in a stationary case, the SPAD regions numbers 142-1 to 142-8 detecting light in the stationary case, the parts short-circuited in an abnormal case, the LDs numbers 131-1 to 131-8 emitting light in the abnormal case, and the SPAD regions numbers 142-1 to 142-8 detecting light in the abnormal case.

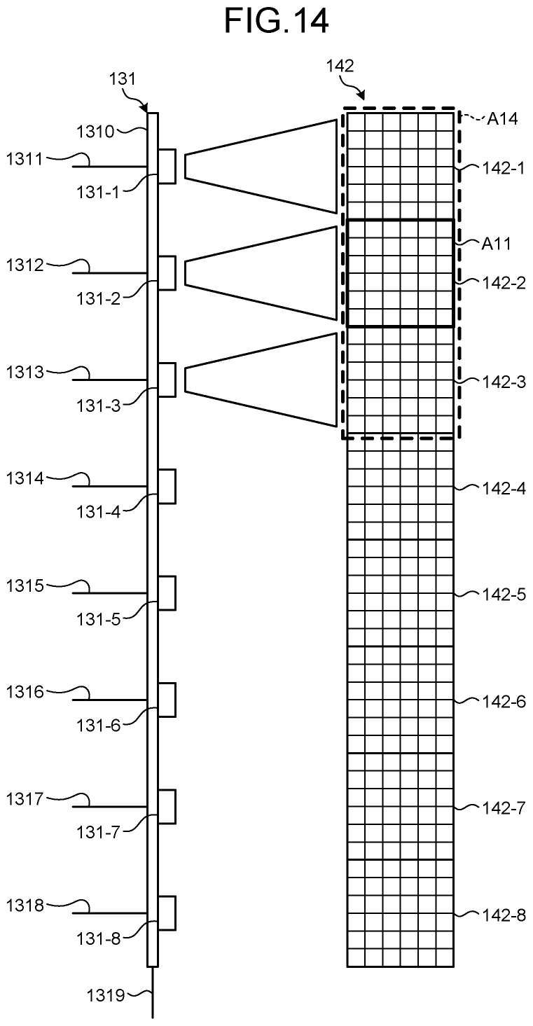

FIG. 14 is a diagram illustrating processing of pattern 2-1 in FIG. 13. In the processing of pattern 2-1, a region irradiated with light by the LDs 131-1 to 131-8 is A11, and a region where the SPAD regions 142-1 to 142-8 detect the light is A14. Specifically, the controller 11 causes the LD 131-2 to emit light on the basis of the LD light emission request, and causes the SPAD region 142-1, the SPAD region 142-2, and the SPAD region 142-3 to detect light on the basis of the SPAD detection region.

At this time, in the stationary case where no failure occurs in the LDs 131-1 to 131-8, the LD 131-2 emits light, the SPAD region 142-2 detects the light, and the SPAD region 142-1 and the SPAD region 142-3 do not detect the light.

On the other hand, in the abnormal case where a short circuit occurs between the anode terminal 1311 of the LD 131-1 and the anode terminal 1312 of the LD 131-2, the power applied to the LD 131-2 is applied to the LD 131-1 and the LD 131-2 by half, and both the LD 131-1 and the LD 131-2 emit light. Then, both the SPAD region 142-1 and the SPAD region 142-2 detect light. Therefore, in the processing of pattern 2-1, when both the SPAD region 142-1 and the SPAD region 142-2 detect light, it is found that a short circuit occurs between the anode terminal 1311 and the anode terminal 1312.

For each pattern illustrated in FIG. 13, when the processing of Steps 1 to 8 in FIGS. 10 and 12 are executed, it is possible to identify whether or not a short circuit has occurred in the anode terminals 1311 to 1318 of the LDs 131-1 to 131-8, and further, it is possible to identify a part where a short circuit has occurred.

### 1.13 Abnormality Detection Method (4)

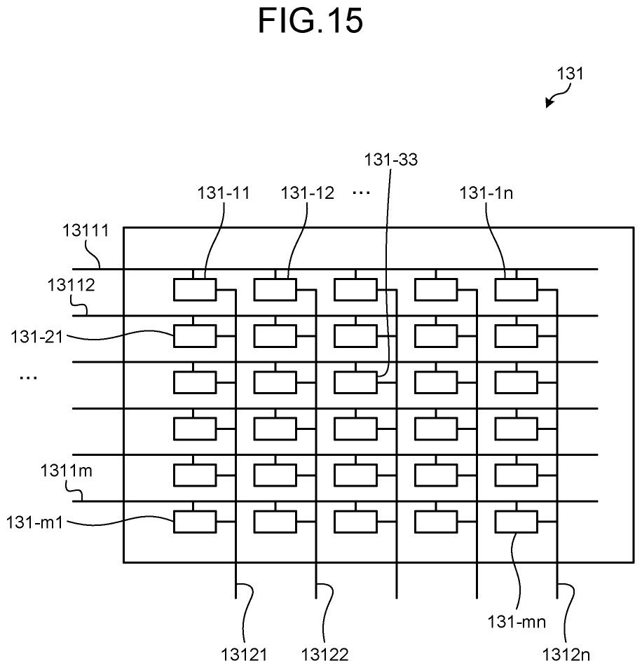

FIG. 15 is a schematic diagram illustrating a schematic configuration example of the LD array. As illustrated in FIG. 15, the LD array 131 may have a configuration including the LDs 131-11 to 131-nm arranged in a two-dimensional lattice pattern. The LDs 131-11 to 131-1n adjacent in the horizontal direction (row direction) share one anode terminal 13111. Similarly, the n LDs adjacent in the horizontal direction share the anode terminals 13112 to 1311m for each row. In addition, the LDs 131-11 to 131-m1 adjacent in the vertical direction (column direction) share one cathode terminal 13121. Similarly, the m LDs adjacent in the vertical direction share the cathode terminals 13122 to 1312n for each column.

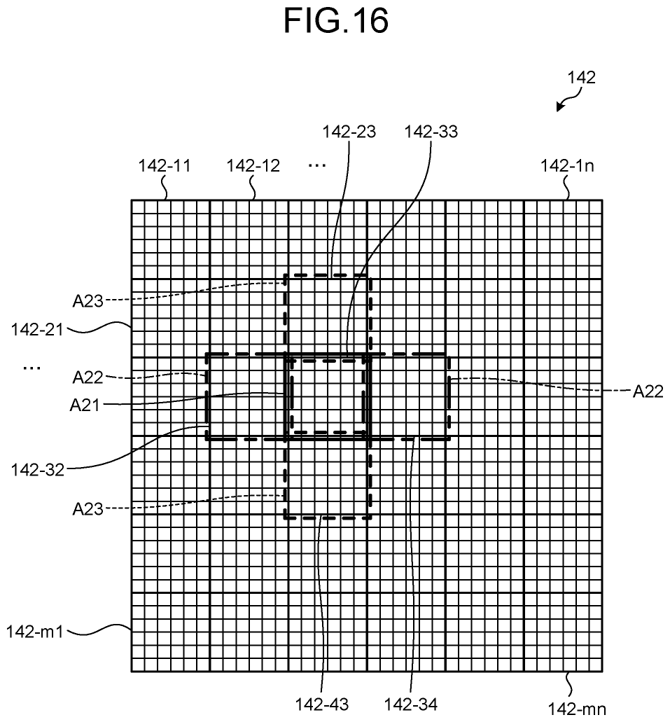

FIG. 16 is a schematic diagram illustrating an example of a light reception pattern in the SPAD array. As illustrated in FIG. 16, the SPAD array 142 is divided into, for example, m regions in the vertical direction and n regions in the horizontal direction. In the example illustrated in FIG. 16, the SPAD array 142 is divided into the SPAD regions 142-11 to 142-mn that receive the laser beams emitted from the LDs 131-11 to 131-mn, respectively.

In FIG. 16, a region irradiated with light by the LD array 131 is A21, and a region where the SPAD array 142 detects the light is A22. Specifically, the controller 11 causes the LD 131-33 that irradiates the region A21 with light to emit light on the basis of the LD light emission request, and causes the SPAD region 142-32, the SPAD region 142-33, and the SPAD region 142-34 corresponding to the region A22 to detect the light on the basis of the SPAD detection region, thereby detecting a short circuit between the anode terminals adjacent in the horizontal direction. By performing this processing by sequentially scanning all the LDs 131-11 to 131-nm and the SPAD regions 142-11 to 142-mn, short-circuiting of all the anode terminals can be detected.

Similarly, the controller 11 causes the LD 131-33 that irradiates the region A21 with light to emit light on the basis of the LD light emission request, and causes the SPAD region 142-23, the SPAD region 142-33, and the SPAD region 142-43 corresponding to the region A23 to detect the light on the basis of the SPAD detection region, thereby detecting a short circuit between the cathode terminals adjacent in the vertical direction. By performing this processing by sequentially scanning all the LDs 131-11 to 131-nm and the SPAD regions 142-11 to 142-mn, short-circuiting of all the cathode terminals can be detected.

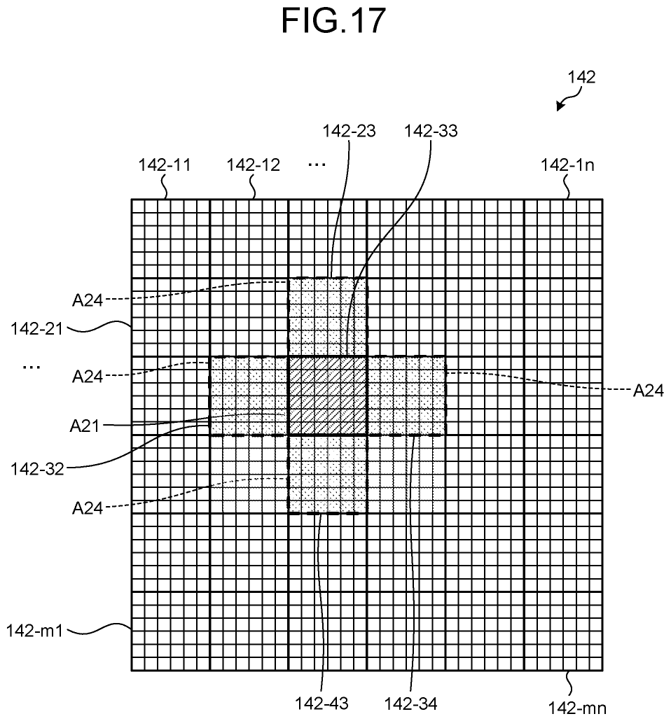

The short circuit detection of the anode terminal corresponding to the region A22 and the short circuit detection of the cathode terminal corresponding to the region A23 may be executed separately, or may be executed at a time. FIG. 17 is a schematic diagram illustrating an example of a light reception pattern in the SPAD array. As illustrated in FIG. 17, the controller 11 causes the LD 131-33 that irradiates the region A21 with light to emit light on the basis of the LD light emission request, and causes the SPAD region 142-23, the SPAD region 142-32, the SPAD region 142-33, the SPAD region 142-34, and the SPAD region 142-43 corresponding to the region A24 to detect the light on the basis of the SPAD detection region, thereby detecting a short circuit between the anode terminals adjacent and the cathode terminals adjacent at a time. By performing this processing by sequentially scanning all the LDs 131-11 to 131-nm and the SPAD regions 142-11 to 142-mn, short-circuiting of all the anode terminals and the cathode terminals can be detected at a time.

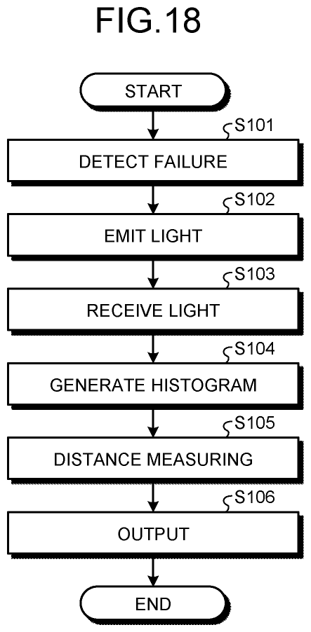

Next, a procedure of processing executed by the ToF sensor 1 will be described using FIG. 18. FIG. 18 is a flowchart illustrating a processing procedure of entire processing executed by the ToF sensor 1.

As illustrated in FIG. 18, for example, the controller 11 detects a failure by executing the patterns illustrated in FIG. 8 in the order illustrated in FIG. 10 (Step S101). Processing when a failure is detected will be described later.

Subsequently, the light emitting unit 13 emits the laser beam L1 by emitting light (Step S102).

Then, the light receiving unit 14 receives the reflected light L2 that is the laser beam L1 being reflected by the object 90 (Step S103).

Thereafter, the calculation unit 15 generates a histogram of the accumulated pixel values based on the detection signal output from the light receiving unit 14 (Step S104).

Then, the controller 11 calculates the distance to the object 90 on the basis of the generated histogram (Step S105).

Subsequently, the controller 11 outputs the calculated distance to the host 80 (Step S106), and ends the processing.

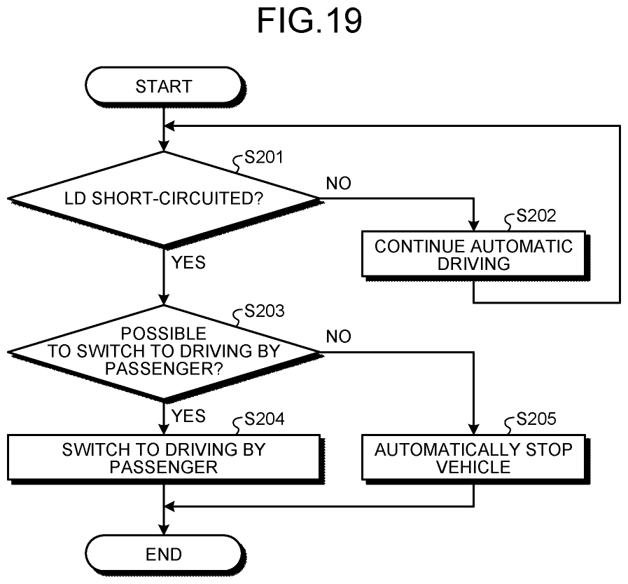

Next, a processing procedure in a case where a failure is detected in Step S101 of FIG. 18 will be described with reference to FIG. 19. FIG. 19 is a flowchart illustrating the processing procedure in the case where a failure occurs. Note that it is assumed that the ToF sensor 1 is installed in a vehicle traveling by automatic driving.

In Step S101 illustrated in FIG. 18, when the determination unit 111 determines that a failure in which the LDs 131-1 to 131-8 are short-circuited does not occur (Step S201: No), the controller 11 continues the automatic driving (Step S202). In other words, the processing of FIG. 18 is continued, and the ToF sensor 1 continues to output the distance measurement result.

In Step S101, when the determination unit 111 determines that a failure in which the LDs 131-1 to 131-8 are short-circuited has occurred (Step S201: Yes), the controller 11 determines whether or not it is possible to switch the driving from the automatic driving to driving by the passenger (Step S203). Specifically, the controller 11 notifies the passenger of a message for selecting whether or not the driving can be switched to the driving by the passenger by display on a display unit such as a car navigation system of the vehicle on which the ToF sensor 1 is mounted or guidance by voice, and determines whether or not the driving can be switched from the automatic driving to the driving by the passenger according to the response of the passenger to the message. When a failure occurs in the LDs 131-1 to 131-8, the power applied to the LDs 131-1 to 131-8 desired to emit light is halved, so that the light intensity becomes weak and the distance cannot be measured far. Therefore, when a failure occurs in the LDs 131-1 to 131-8, it is preferable to stop the automatic driving.

In a case where the passenger responds to the message that the driving can be switched to the driving by the passenger, the controller 11 determines that the driving can be switched from the automatic driving to the driving by the passenger (Step S203: Yes), and switches from the automatic driving to the driving by the passenger (Step S204).

On the other hand, in a case where the passenger responds to the message that the driving cannot be switched to the driving by the passenger, the controller 11 determines that the driving cannot be switched from the automatic driving to the driving by the passenger (Step S203: No), and automatically stops the vehicle on which the ToF sensor 1 is mounted (Step S205).

As described above, when determination unit 111 determines that the light emitting unit 13 is abnormal while a mobile body such as the vehicle is traveling in the automatic driving, the controller 11 performs control to switch the automatic driving to the manual driving or stop the mobile body. As a result, when the light emitting unit 13 has a failure, it is possible to ensure the safety of the vehicle in which the ToF sensor 1 is installed.

### 2. APPLICATION EXAMPLE

The technology according to the present disclosure can be applied to various products. For example, the technology according to the present disclosure may be realized as a device mounted on any type of mobile body such as automobiles, electric vehicles, hybrid electric vehicles, motorcycles, bicycles, personal mobilities, airplanes, drones, ships, robots, construction machines, or agricultural machines (tractors).

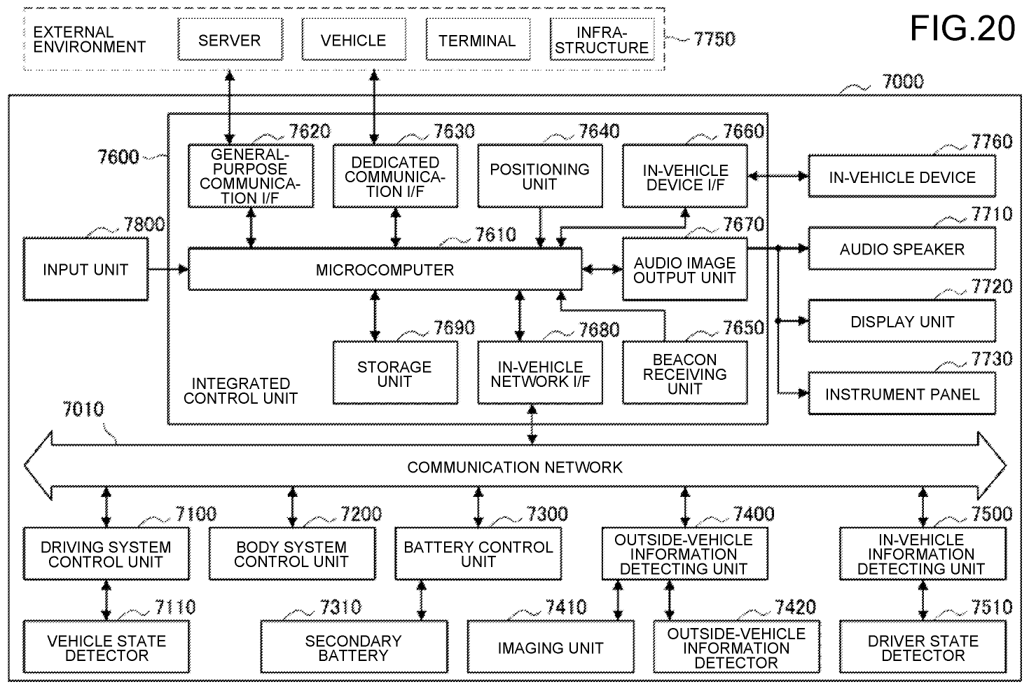

FIG. 20 is a block diagram illustrating a schematic configuration example of a vehicle control system 7000 which is an example of a mobile body control system to which a technology according to the present disclosure is applicable. The vehicle control system 7000 includes a plurality of electronic control units connected to each other via a communication network 7010. In the example illustrated in FIG. 20, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units may be, for example, an in-vehicle communication network conforming to an arbitrary standard such as a controller area network (CAN), a local interconnect network (LIN), a local area network (LAN), or FlexRay (registered trademark).

Each control unit includes a microcomputer that performs arithmetic processing according to various programs, a storage unit that stores programs executed by the microcomputer, parameters used for various calculations, or the like, and a drive circuit that drives various devices to be controlled. Each control unit includes a network I/F for communicating with other control units via the communication network 7010, and a communication I/F for communicating with devices, sensors, or the like inside and outside the vehicle by wired communication or wireless communication. In FIG. 20, as a functional configuration of the integrated control unit 7600, a microcomputer 7610, a general-purpose communication I/F 7620, a dedicated communication I/F 7630, a positioning unit 7640, a beacon receiving unit 7650, an in-vehicle device I/F 7660, an audio image output unit 7670, an in-vehicle network I/F 7680, and a storage unit 7690 are illustrated. The other control units similarly include a microcomputer, a communication I/F, a storage unit, and the like.

The driving system control unit 7100 controls the operation of devices related to the driving system of the vehicle in accordance with various programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device such as an antilock brake system (ABS) or an electronic stability control (ESC).

A vehicle state detector 7110 is connected to the driving system control unit 7100. The vehicle state detector 7110 includes, for example, at least one of a gyro sensor that detects an angular velocity of axial rotational motion of a vehicle body, an acceleration sensor that detects acceleration of the vehicle, or a sensor for detecting an operation amount of an accelerator pedal, an operation amount of a brake pedal, a steering angle of a steering wheel, an engine speed, a wheel rotation speed, or the like. The driving system control unit 7100 performs arithmetic processing using a signal input from the vehicle state detector 7110, and controls an internal combustion engine, a driving motor, an electric power steering device, a brake device, or the like.

The body system control unit 7200 controls the operation of various kinds of devices provided to a vehicle body in accordance with various programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls the secondary battery 7310, which is a power supply source of the driving motor, according to various programs. For example, information such as a battery temperature, a battery output voltage, or a remaining capacity of a battery is input to the battery control unit 7300 from a battery device including the secondary battery 7310. The battery control unit 7300 performs arithmetic processing using these signals, and performs temperature adjustment control of the secondary battery 7310 or control of a cooling device or the like included in the battery device.

The outside-vehicle information detecting unit 7400 detects information about the outside of the vehicle including the vehicle control system 7000. For example, at least one of an imaging unit 7410 and an outside-vehicle information detector 7420 is connected to the outside-vehicle information detecting unit 7400. The imaging unit 7410 includes at least one of a time of flight (ToF) camera, a stereo camera, a monocular camera, an infrared camera, or other cameras. The outside-vehicle information detector 7420 includes, for example, at least one of an environment sensor for detecting current weather or climate, or a surrounding information detection sensor for detecting another vehicle, an obstacle, a pedestrian, or the like around the vehicle on which the vehicle control system 7000 is mounted.

The environment sensor may be, for example, at least one of a raindrop sensor that detects rainy weather, a fog sensor that detects fog, a sunshine sensor that detects a degree of sunshine, and a snow sensor that detects snowfall. The surrounding information detection sensor may be at least one of an ultrasonic sensor, a radar device, or a light detection and ranging, laser imaging detection and ranging (LIDAR) device. The imaging unit 7410 and the outside-vehicle information detector 7420 may be provided as independent sensors or devices, or may be provided as a device in which a plurality of sensors or devices is integrated.

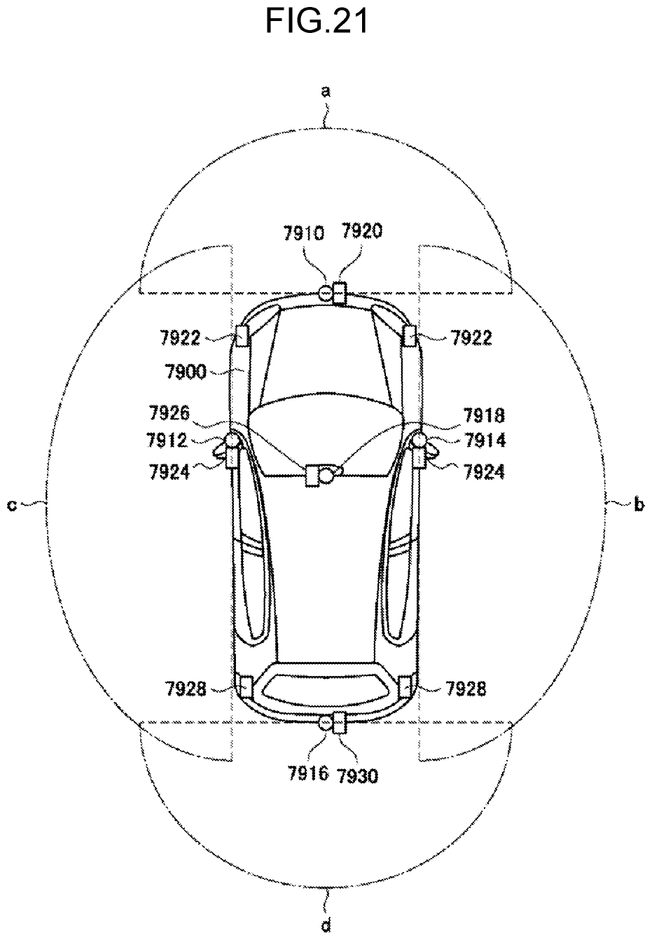

Here, FIG. 21 is a diagram illustrating an example of installation positions of the imaging unit 7410 and the outside-vehicle information detector 7420. Imaging units 7910, 7912, 7914, 7916, and 7918 are positioned at, for example, at least any one of the front nose, a side mirror, the rear bumper, the back door, and the upper part of the windshield in the vehicle compartment of the vehicle 7900. The imaging unit 7910 provided to the front nose and the imaging unit 7918 provided to the upper part of the windshield in the vehicle compartment obtain mainly an image of the front of the vehicle 7900. The imaging units 7912 and 7914 attached to the side mirrors obtain mainly images of the areas on the sides of the vehicle 7900. The imaging unit 7916 provided to the rear bumper or the back door obtains mainly an image of the rear of the vehicle 7900. The imaging unit 7918 provided to the upper part of the windshield in the vehicle compartment is used mainly to detect a preceding vehicle, a pedestrian, an obstacle, a signal, a traffic sign, a lane, or the like.

Additionally, FIG. 21 illustrates an example of the imaging ranges of the respective imaging units 7910, 7912, 7914, and 7916. An imaging range a represents the imaging range of the imaging unit 7910 provided to the front nose. Imaging ranges b and c respectively represent the imaging ranges of the imaging units 7912 and 7914 provided to the side mirrors. An imaging range d represents the imaging range of the imaging unit 7916 provided to the rear bumper or the back door. A bird's-eye image of the vehicle 7900 as viewed from above is obtained by superimposing image data imaged by the imaging units 7910, 7912, 7914, and 7916, for example.

The outside-vehicle information detectors 7920, 7922, 7924, 7926, 7928, and 7930 provided at the front, rear, sides, corners, and the upper part of the windshield in the vehicle compartment of the vehicle 7900 may be, for example, ultrasonic sensors or radar devices. The outside-vehicle information detectors 7920, 7926, and 7930 provided at the front nose, the rear bumper, the back door, and the upper part of the windshield in the vehicle compartment of the vehicle 7900 may be, for example, LIDAR devices. These outside-vehicle information detectors 7920 to 7930 are mainly used for detecting a preceding vehicle, a pedestrian, an obstacle, or the like.

Returning to FIG. 20, the description will be continued. The outside-vehicle information detecting unit 7400 makes the imaging unit 7410 image an image of the outside of the vehicle, and receives the imaged image data. Furthermore, the outside-vehicle information detecting unit 7400 receives detection information from the connected outside-vehicle information detector 7420. In a case where the outside-vehicle information detector 7420 is an ultrasonic sensor, a radar device, or a LIDAR device, the outside-vehicle information detecting unit 7400 transmits ultrasonic waves, electromagnetic waves, or the like, and receives information of received reflected waves. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing rainfall, fog, road surface conditions, or the like on the basis of the received information. The outside-vehicle information detecting unit 7400 may calculate a distance to an object outside the vehicle on the basis of the received information.

Furthermore, on the basis of the received image data, the outside-vehicle information detecting unit 7400 may perform processing of image recognition for recognizing a human, a vehicle, an obstacle, a sign, a character on a road surface, or the like, or processing of detecting a distance thereto. The outside-vehicle information detecting unit 7400 may perform processing such as distortion correction or alignment on the received image data, and combine image data captured by different imaging units 7410 to generate a bird's-eye view image or a panoramic image. The outside-vehicle information detecting unit 7400 may perform viewpoint conversion processing using image data captured by different imaging units 7410.

The in-vehicle information detecting unit 7500 detects information about the inside of the vehicle. The in-vehicle information detecting unit 7500 is, for example, connected with a driver state detector 7510 that detects the state of a driver. The driver state detector 7510 may include a camera that images the driver, a biological sensor that detects biological information of the driver, a microphone that collects sound in the vehicle compartment, or the like. The biological sensor is provided, for example, on a seat surface, a steering wheel, or the like, and detects biological information of the passenger sitting on a seat or the driver holding the steering wheel. On the basis of detection information input from the driver state detector 7510, the in-vehicle information detecting unit 7500 may calculate a degree of fatigue of the driver or a degree of concentration of the driver, or may determine whether the driver is dozing. The in-vehicle information detecting unit 7500 may perform processing such as noise canceling processing on the collected sound signal.

The integrated control unit 7600 controls the overall operation in the vehicle control system 7000 in accordance with various programs. An input unit 7800 is connected to the integrated control unit 7600. The input unit 7800 is realized by, for example, a device that can be operated by an occupant for input, such as a touch panel, a button, a microphone, a switch, or a lever. Data obtained by performing voice recognition on the voice input by the microphone may be input to the integrated control unit 7600. The input unit 7800 may be, for example, a remote control device using infrared rays or other radio waves, or an external connection device such as a mobile phone or a personal digital assistant (PDA) corresponding to the operation of the vehicle control system 7000. The input unit 7800 may be, for example, a camera, and in this case, the passenger can input information by gesture. Alternatively, data obtained by detecting the movement of the wearable device worn by the passenger may be input. Furthermore, the input unit 7800 may include, for example, an input control circuit or the like that generates an input signal on the basis of information input by the passenger or the like using the input unit 7800 and outputs the input signal to the integrated control unit 7600. By operating the input unit 7800, the passenger or the like inputs various data to the vehicle control system 7000 or instructs a processing operation.

The storage unit 7690 may include a read only memory (ROM) that stores various programs to be executed by the microcomputer, and a random access memory (RAM) that stores various parameters, calculation results, sensor values, or the like. In addition, the storage unit 7690 may be realized by a magnetic storage device such as a hard disc drive (HDD), a semiconductor storage device, an optical storage device, a magneto-optical storage device, or the like.

The general-purpose communication I/F 7620 is a general-purpose communication I/F that mediates communication with various devices existing in an external environment 7750. The general-purpose communication I/F 7620 may implement a cellular communication protocol such as Global System of Mobile communications (GSM) (registered trademark), WiMAX (registered trademark), Long Term Evolution (LTE) (registered trademark), or LTE-Advanced (LTE-A), or other wireless communication protocols such as a wireless LAN (also referred to as Wi-Fi (registered trademark)) and Bluetooth (registered trademark). The general-purpose communication I/F 7620 may be connected to a device (for example, an application server or a control server) existing on an external network (for example, the Internet, a cloud network, or a company-specific network) via, for example, a base station or an access point. Furthermore, the general-purpose communication I/F 7620 may be connected to a terminal (for example, a terminal of a driver, a pedestrian, or a store, or a machine type communication (MTC) terminal) existing in the vicinity of the vehicle using, for example, a peer to peer (P2P) technology.

The dedicated communication I/F 7630 is a communication I/F that supports a communication protocol formulated for use in a vehicle. For example, the dedicated communication I/F 7630 may implement a standard protocol such as wireless access in vehicle environment (WAVE) which is a combination of IEEE 802.11p of the lower layer and IEEE 1609 of the upper layer, dedicated short range communications (DSRC), or a cellular communication protocol. The dedicated communication I/F 7630 typically performs V2X communication which is a concept including one or more of vehicle to vehicle communication, vehicle to infrastructure communication, vehicle to home communication, and vehicle to pedestrian communication. The positioning unit 7640 receives, for example, a global navigation satellite system (GNSS) signal from a GNSS satellite (for example, a global positioning system (GPS) signal from a GPS satellite), executes positioning, and generates position information including the latitude, longitude, and altitude of the vehicle. Note that the positioning unit 7640 may specify the current position by exchanging signals with a wireless access point, or may acquire the position information from a terminal such as a mobile phone, a PHS, or a smartphone having a positioning function.

The beacon receiving unit 7650 receives, for example, radio waves or electromagnetic waves transmitted from a wireless station or the like installed on a road, and acquires information such as a current position, a traffic jam, a closed road, a required time, or the like. Note that the function of the beacon receiving unit 7650 may be included in the dedicated communication I/F 7630 described above.

The in-vehicle device I/F 7660 is a communication interface that mediates connection between the microcomputer 7610 and various in-vehicle devices 7760 existing in the vehicle. The in-vehicle device I/F 7660 may establish wireless connection using a wireless communication protocol such as wireless LAN, Bluetooth (registered trademark), near field communication (NFC), or wireless USB (WUSB). Furthermore, the in-vehicle device I/F 7660 may establish wired connection such as universal serial bus (USB), high-definition multimedia interface (HDMI) (registered trademark), or mobile high-definition link (MHL) via a connection terminal (and, if necessary, a cable.) not illustrated. The in-vehicle device 7760 may include, for example, at least one of a mobile device or a wearable device possessed by the passenger, or an information device carried in or attached to the vehicle. Furthermore, the in-vehicle device 7760 may include a navigation device that searches for a route to an arbitrary destination. The in-vehicle device I/F 7660 exchanges a control signal or a data signal with these in-vehicle devices 7760.

The in-vehicle network I/F 7680 is an interface that mediates communication between the microcomputer 7610 and the communication network 7010. The in-vehicle network I/F 7680 transmits and receives signals and the like in accordance with a predetermined protocol supported by the communication network 7010.

The microcomputer 7610 of the integrated control unit 7600 controls the vehicle control system 7000 according to various programs on the basis of information acquired via at least one of the general-purpose communication I/F 7620, the dedicated communication I/F 7630, the positioning unit 7640, the beacon receiving unit 7650, the in-vehicle device I/F 7660, or the in-vehicle network I/F 7680. For example, the microcomputer 7610 may calculate a control target value for the driving force generating device, the steering mechanism, or the braking device on the basis of the information about the inside or outside of the vehicle to be obtained, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the information about the obtained information of surroundings of the vehicle which information is obtained.

The microcomputer 7610 may generate three-dimensional distance information between the vehicle and an object such as a surrounding structure or a person on the basis of information acquired via at least one of the general-purpose communication I/F 7620, the dedicated communication I/F 7630, the positioning unit 7640, the beacon receiving unit 7650, the in-vehicle device I/F 7660, or the in-vehicle network I/F 7680, and create local map information including surrounding information of the current position of the vehicle. Furthermore, the microcomputer 7610 may predict danger such as collision of the vehicle, approach of a pedestrian or the like, or entry into a closed road on the basis of the acquired information, and generate a warning signal. The warning signal may be, for example, a signal for generating a warning sound or turning on a warning lamp.

The audio image output unit 7670 transmits an output signal of at least one of a sound or an image to an output device capable of visually or auditorily notifying an occupant of the vehicle or the outside of the vehicle of information. In the example of FIG. 20, an audio speaker 7710, a display unit 7720, and an instrument panel 7730 are exemplified as the output device. The display unit 7720 may, for example, include at least one of an on-board display or a head-up display. The display unit 7720 may have an augmented reality (AR) display function. The output device may be another device other than these devices, such as a wearable device such as a headphone or an eyeglass-type display worn by a passenger, a projector, or a lamp. In a case where the output device is a display device, the display device visually displays results obtained by various processes performed by the microcomputer 7610 or information received from another control unit in various formats such as text, images, tables, and graphs. Furthermore, in a case where the output device is a sound output device, the sound output device converts an audio signal including reproduced sound data, acoustic data, or the like into an analog signal and aurally outputs the analog signal.

Note that, in the example illustrated in FIG. 20, at least two control units connected via the communication network 7010 may be integrated as one control unit. Alternatively, each control unit may include a plurality of control units. Further, the vehicle control system 7000 may include another control unit (not illustrated). In the above description, some or all of the functions performed by any of the control units may be provided to another control unit. That is, as long as information is transmitted and received via the communication network 7010, predetermined arithmetic processing may be performed by any control unit. Similarly, a sensor or a device connected to any of the control units may be connected to another control unit, and a plurality of control units may mutually transmit and receive detection information via the communication network 7010.

Note that a computer program for realizing each function of the ToF sensor 1 according to the present embodiment described with reference to FIG. 1 can be mounted on any control unit or the like. Furthermore, it is also possible to provide a computer-readable recording medium storing such a computer program. The recording medium is, for example, a magnetic disk, an optical disk, a magneto-optical disk, a flash memory, or the like. Furthermore, the computer program described above may be distributed via, for example, a network without using a recording medium.

In the vehicle control system 7000 described above, the ToF sensor 1 according to the present embodiment described with reference to FIG. 1 can be applied to the integrated control unit 7600 of the application example illustrated in FIG. 20. For example, the controller 11, the calculation unit 15, and the external I/F 19 of the ToF sensor 1 correspond to the microcomputer 7610, the storage unit 7690, and the in-vehicle network I/F 7680 of the integrated control unit 7600. However, the present invention is not limited thereto, and the vehicle control system 7000 may correspond to the host 80 in FIG. 1.

Furthermore, at least some components of the ToF sensor 1 described with reference to FIG. 1 may be realized in a module (for example, an integrated circuit module including one die) for the integrated control unit 7600 illustrated in FIG. 20. Alternatively, the ToF sensor 1 described with reference to FIG. 1 may be realized by a plurality of control units of the vehicle control system 7000 illustrated in FIG. 20.

### 3. SUMMARY

As described above, according to an embodiment of the present disclosure, the light receiving device 2 according to the present embodiment includes the light receiving unit 14 and the controller 11. The light receiving unit 14 includes a first light receiving element (for example, the SPAD region 142-1) that receives light emitted by the first light emitting element (for example, LD 131-1), and a second light receiving element (for example, (SPAD region 142-2)) that that receives light emitted by a second light emitting element (for example, LD 131-2) that is disposed adjacent to the first light emitting element and shares an anode terminal or a cathode terminal (for example, cathode terminal 1319) with the first light emitting element. The controller 11 controls the first light receiving element and the second light receiving element so that the first light receiving element and the second light receiving element receive light when the first light receiving element emits light. This makes it possible to detect a short circuit between the anode terminal 1311 of the LD 131-1 and the anode terminal 1312 of the LD 131-2 adjacent in the vertical direction. By repeatedly executing this process as illustrated in FIG. 10 or 12, it is possible to detect a short circuit for all the LDs 131-1 to 131-8. Therefore, according to the light receiving device 2, abnormality of a light emitting element can be detected when a plurality of light emitting elements share an anode terminal or a cathode terminal.

Although the embodiments of the present disclosure have been described above, the technical scope of the present disclosure is not limited to the embodiments described above as it is, and various modifications can be made without departing from the gist of the present disclosure. In addition, constituent elements of different embodiments and modifications may be appropriately combined.

Furthermore, the effects of the embodiments described in the present specification are merely examples and are not limited, and other effects may be provided. Furthermore, the effects described in the present specification are merely examples and are not limited, and other effects may be provided.

Note that the present technology can also have the following configurations.

(1)

A light receiving device, comprising:
a light receiving unit including a first light receiving element that receives light emitted by a first light emitting element and a second light receiving element that receives light emitted by a second light emitting element that is disposed adjacent to the first light emitting element and shares an anode terminal or a cathode terminal with the first light emitting element; and
a controller that controls the first light receiving element and the second light receiving element to cause the first light receiving element and the second light receiving element to receive light when the first light receiving element emits light.
   (2)

The light receiving device according to (1), comprising a determination unit that determines that a light emitting unit including the first light emitting element and the second light emitting element is abnormal in a case where the second light receiving element detects light when the first light receiving element emits light.

(3)

The light receiving device according to (1) or (2), wherein the light receiving device is installed on a mobile body.

(4)

The light receiving device according to (3), wherein when the determination unit determines that the light emitting unit is abnormal while the mobile body is traveling in an automatic driving, the controller performs control to switch the automatic driving to a manual driving or stop the mobile body.

(5)

The light receiving device according to any one of (1) to (4), wherein
the light receiving unit includes a third light receiving element that is disposed adjacent to the first light emitting element sharing an anode terminal or a cathode terminal with the first light emitting element and that receives light emitted by a third light emitting element, and
the controller controls the first light receiving element, the second light receiving element, and the third light receiving element to cause the first light receiving element, the second light receiving element, and the third light receiving element to receive light when the first light receiving element emits light.
   (6)

A distance measuring device, comprising:
a light emitting unit including a first light emitting element, and a second light emitting element that is disposed adjacent to the first light emitting element sharing an anode terminal or a cathode terminal with the first light emitting element;
a light receiving unit including a first light receiving element that receives light emitted by the first light emitting element and a second light receiving element that receives light emitted by the second light emitting element; and
a controller that controls the first light receiving element and the second light receiving element to cause the first light receiving element and the second light receiving element to receive light when the first light receiving element emits light.
   (7)

A method for controlling a light receiving device including: a light receiving unit including a first light receiving element that receives light emitted by a first light emitting element and a second light receiving element that receives light emitted by a second light emitting element that is disposed adjacent to the first light emitting element and shares an anode terminal or a cathode terminal with the first light emitting element; and a controller that controls the light receiving unit, the method comprising
controlling, by the controller, the first light receiving element and the second light receiving element to cause the first light receiving element and the second light receiving element to receive light when the first light receiving element emits light.

### REFERENCE SIGNS LIST

1 TOF SENSOR (DISTANCE MEASURING DEVICE)
2 LIGHT RECEIVING DEVICE
11 CONTROLLER
13 LIGHT EMITTING UNIT
14 LIGHT RECEIVING UNIT
15 CALCULATION UNIT
20 SPAD PIXEL
30 MACRO PIXEL
80 HOST
90 OBJECT

1. A light receiving device, comprising:
a light receiving unit including a first light receiving element that receives light emitted by a first light emitting element and a second light receiving element that receives light emitted by a second light emitting element that is disposed adjacent to the first light emitting element and shares an anode terminal or a cathode terminal with the first light emitting element; and
a controller that controls the first light receiving element and the second light receiving element to cause the first light receiving element and the second light receiving element to receive light when the first light receiving element emits light.

2. The light receiving device according to claim 1, comprising a determination unit that determines that a light emitting unit including the first light emitting element and the second light emitting element is abnormal in a case where the second light receiving element detects light when the first light receiving element emits light.

3. The light receiving device according to claim 2, wherein the light receiving device is installed on a mobile body.

4. The light receiving device according to claim 3, wherein when the determination unit determines that the light emitting unit is abnormal while the mobile body is traveling in an automatic driving, the controller performs control to switch the automatic driving to a manual driving or stop the mobile body.

5. The light receiving device according to claim 1, wherein
the light receiving unit includes a third light receiving element that is disposed adjacent to the first light emitting element sharing an anode terminal or a cathode terminal with the first light emitting element and that receives light emitted by a third light emitting element, and
the controller controls the first light receiving element, the second light receiving element, and the third light receiving element to cause the first light receiving element, the second light receiving element, and the third light receiving element to receive light when the first light receiving element emits light.

6. A distance measuring device, comprising:
a light emitting unit including a first light emitting element, and a second light emitting element that is disposed adjacent to the first light emitting element sharing an anode terminal or a cathode terminal with the first light emitting element;
a light receiving unit including a first light receiving element that receives light emitted by the first light emitting element and a second light receiving element that receives light emitted by the second light emitting element; and
a controller that controls the first light receiving element and the second light receiving element to cause the first light receiving element and the second light receiving element to receive light when the first light receiving element emits light.

7. A method for controlling a light receiving device including: a light receiving unit including a first light receiving element that receives light emitted by a first light emitting element and a second light receiving element that receives light emitted by a second light emitting element that is disposed adjacent to the first light emitting element and shares an anode terminal or a cathode terminal with the first light emitting element; and a controller that controls the light receiving unit, the method comprising
controlling, by the controller, the first light receiving element and the second light receiving element to cause the first light receiving element and the second light receiving element to receive light when the first light receiving element emits light.
